(19) United States
(12) Patent Application Publication
(10) Pub. No.: US 2016/0034165 A1
(43) Pub. Date: Feb. 4, 2016

(54) ACTIVITY PROCESSING METHOD AND ELECTRONIC DEVICE SUPPORTING THE SAME

(71) Applicant: Samsung Electronics Co., Ltd., Suwon-si (KR)

(72) Inventors: Kyung Min KIM, Suwon-si (KR); Sang Kon SONG, Suwon-si (KR)

(21) Appl. No.: 14/812,497

(22) Filed: Jul. 29, 2015

(30) Foreign Application Priority Data
Jul. 30, 2014 (KR) 10-2014-0097539

(51) Int. Cl. G06F 3/0484; G06F 3/0488

(52) U.S. Cl. CPC G06F 3/04847; G06F 3/0488; G06F 3/04842

(57) ABSTRACT

An activity processing method in an electronic device and an electronic device for performing the method are provided. The method includes displaying on a screen an execution window relating to at least one activity occurring according to an execution of an application, receiving a processing input of a user, storing in a buffer the at least one activity corresponding to a range determined by the processing input, removing an execution window relating to the at least one stored activity from the screen, and terminating the at least one stored activity.

CROSS-REFERENCE TO RELATED APPLICATION(S)

This application claims the benefit under 35 U.S.C. §119(a) of a Korean patent application filed on Jul., 30, 2014 in the Korean Intellectual Property Office and assigned Serial number 10-2014-0097539, the entire disclosure of which is hereby incorporated by reference.

### TECHNICAL FIELD

The present disclosure relates to an activity processing method of an electronic device. More particularly, the present disclosure relates to an activity processing method for collectively processing a certain number of activities according to a user's processing input and an electronic device supporting the same.

### BACKGROUND

Generally, an electronic device may generate various activities according to the execution of an application. A user may receive related information or input certain data through an execution window related to a corresponding activity.

When an activity is activated in accordance with the execution of an application of an electronic device, the above related art is required to press a close button of each execution window or a back button of the electronic device repeatedly in order to close a corresponding activity related execution window.

Therefore, a need exists for an activity processing method for collectively processing a certain number of activities according to a user's processing input and an electronic device supporting the same.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an activity processing method for collectively processing a certain number of activities according to a user's processing input and an electronic device supporting the same.

In accordance with an aspect of the present disclosure, an activity processing method in an electronic device is provided. The method includes displaying on a screen an execution window relating to at least one activity occurring according to an execution of an application, receiving a processing input of a user, storing in a buffer the at least one activity corresponding to a range determined by the processing input, removing an execution window relating to the at least one stored activity from the screen, and terminating the at least one stored activity.

In accordance with another aspect of the present disclosure, an electronic device is provided. The electronic device includes an application control module, and a buffer. The application control module displays on a screen at least one execution window occurring according to an execution of an application. The buffer stores an activity relating to an execution window corresponding to a range determined by a processing input. The application control module removes an execution window corresponding to the stored activity from the screen and terminates the stored activity.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a network environment including a first electronic device according to various embodiments of the present disclosure;

FIG. 2 is a block diagram of an electronic device according to various embodiments of the present disclosure;

FIG. 3 is a flowchart illustrating an activity processing method according to various embodiments of the present disclosure;

FIG. 4 is a flowchart illustrating a method of terminating an activity according to various embodiments of the present disclosure;

FIGS. 5A, 5B, 5C, 5D, and 5E are views of a screen illustrating a removal process of an activity execution window according to various embodiments of the present disclosure;

FIGS. 6A, 6B, 6C, 6D, and 6E are views of a screen illustrating a restoration process of an activity execution window according to various embodiments of the present disclosure;

FIG. 7 is a view of a screen illustrating an activity storing process using a button according to an embodiment of the present disclosure;

FIG. 8 is a view of a screen illustrating an activity storing process using a gesture according to an embodiment of the present disclosure; and

FIG. 9 is a view of a screen illustrating an activity storing process using a moving bar according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The term “include,” “comprise,” and “have”, or “may include,” or “may comprise” and “may have” used herein indicates disclosed functions, operations, or existence of elements but does not exclude other functions, operations or elements. Additionally, in various embodiments of the present disclosure, the term “include,” “comprise,” “including,” or “comprising,” specifies a property, a region, a fixed number, an operation, a process, an element and/or a component but does not exclude other properties, regions, fixed numbers, operations, processes, elements and/or components.

In various embodiments of the present disclosure, the expression “A or B” or “at least one of A or/and B” may include all possible combinations of items listed together. For instance, the expression “A or B”, or “at least one of A or/and B” may indicate include A, B, or both A and B.

The terms, such as “1st”, “2nd”, “first”, “second”, and the like, used herein may refer to modifying various different elements of various embodiments of the present disclosure, but do not limit the elements. For instance, such expressions do not limit the order and/or importance of corresponding components. The expressions may be used to distinguish one element from another element. For instance, both “a first user device” and “a second user device” indicate a user device but indicate different user devices from each other. For example, a first component may be referred to as a second component and vice versa without departing from the scope of the present disclosure.

In an embodiment of the present disclosure below, when one part (or element, device, and the like) is referred to as being “connected” to another part (or element, device, and the like), it should be understood that the former can be “directly connected” to the latter, or “connected” to the latter via an intervening part (or element, device, and the like). In contrast, when an element is referred to as being “directly connected” or “directly coupled” to another element, there are no intervening elements present.

Otherwise indicated herein, all the terms used herein, which include technical or scientific terms, may have the same meaning that is generally understood by a person skilled in the art. In general, the terms defined in the dictionary should be considered to have the same meaning as the contextual meaning of the related art, and, unless clearly defined herein, should not be understood abnormally or as having an excessively formal meaning.

An electronic device according to various embodiments of the present disclosure may be a device with a screen display function. For instance, electronic devices may include at least one of smartphones, tablet personal computers (PCs), mobile phones, video phones, electronic book (e-book) readers, desktop PCs, laptop PCs, netbook computers, personal digital assistants (PDAs), portable multimedia player (PMPs), a motion pictures expert group (MPEG-1 or MPEG-2) audio layer 3 (MP3) players, mobile medical devices, cameras, and wearable devices (for example, head-mounted-devices (HMDs), such as electronic glasses, an electronic apparel, electronic bracelets, electronic necklaces, electronic appcessories, electronic tattoos, smart watches, and the like).

According to some embodiments of the present disclosure, electronic devices may be smart home appliances having a screen display function. The smart home appliances may include at least one of, for example, televisions (TV), digital video disc (DVD) players, audios, refrigerators, air conditioners, cleaners, ovens, microwave ovens, washing machines, air cleaners, set-top boxes, TV boxes (for example, Samsung HomeSync™, Apple TV™ or Google TV™), game consoles, electronic dictionaries, electronic keys, camcorders, and electronic picture frames.

According to some embodiments of the present disclosure, an electronic device may include at least one of various medical devices (for example, magnetic resonance angiography (MRA) devices, magnetic resonance imaging (MRI) devices, computed tomography (CT) devices, medical imaging devices, ultrasonic devices, and the like), navigation devices, global positioning system (GPS) receivers, event data recorders (EDRs), flight data recorders (FDRs), vehicle infotainment devices, marine electronic equipment (for example, marine navigation systems, gyro compasses, and the like), avionics, security equipment, vehicle head modules, industrial or household robots, financial institutions' automatic teller machines (ATMs), and stores' point of sales (POS), each of which has a screen display function.

In various embodiments of the present disclosure, an electronic device may include at least one of part of furniture or buildings/structures supporting call forwarding service, electronic boards, electronic signature receiving devices, projectors, and various measuring instruments (for example, water, electricity, gas, or radio signal measuring instruments), each of which has a screen display function. An electronic device according to various embodiments of the present disclosure may be one of the above-mentioned various devices or a combination thereof. Additionally, an electronic device according to various embodiments of the present disclosure may be a flexible device. Furthermore, it is apparent to those skilled in the art that an electronic device according to various embodiments of the present disclosure is not limited to the above-mentioned devices.

Hereinafter, an activity processing technique according to various embodiments of the present disclosure will be described with reference to the accompanying drawings. The term “user” in various embodiments may refer to a person using an electronic device or a device using an electronic device (for example, an artificial intelligent electronic device).

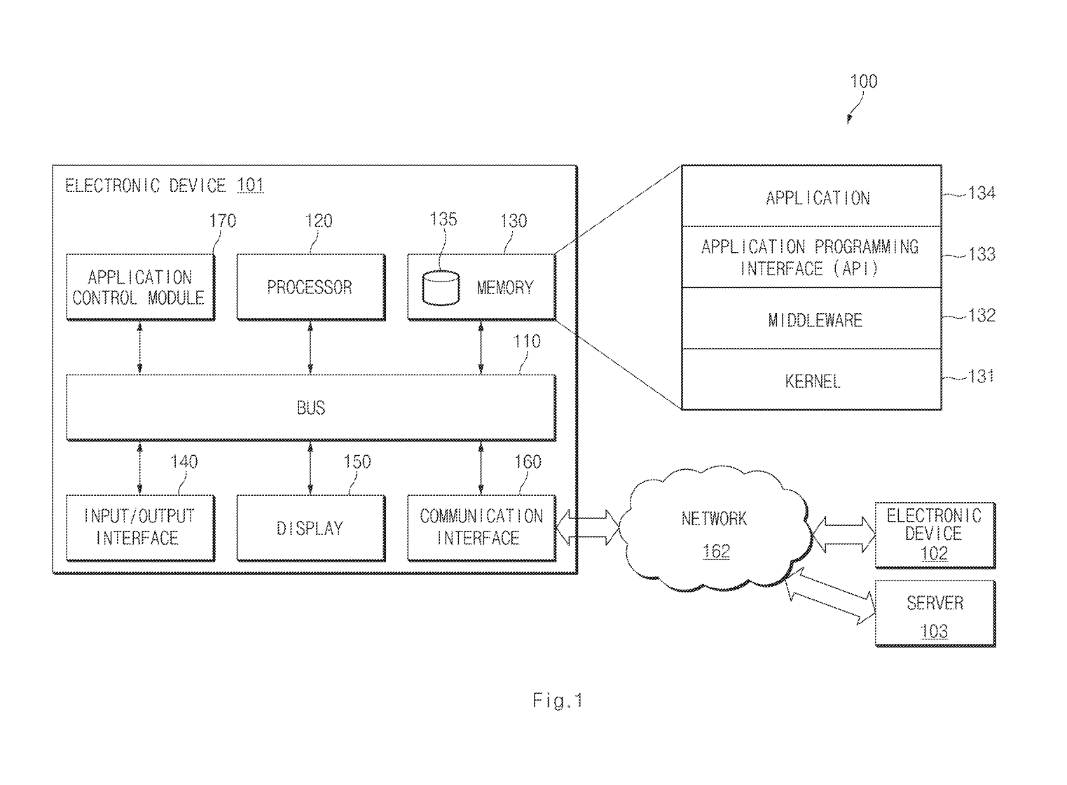

FIG. 1 is a view illustrating a network environment including a first electronic device according to various embodiments of the present disclosure.

Referring to FIG. 1, a first electronic device 101 may include a bus 110, a processor 120, a memory 130, an input/output interface 140, a display 150, a communication interface 160, and an application control module 170.

The bus 110 may be a circuit connecting the above-mentioned components to each other and delivering a communication (for example, a control message) between the above-mentioned components.

The processor 120, for example, may receive instructions from the above-mentioned other components (for example, the memory 130, the input/output interface 140, the display 150, the communication interface 160, and the application control module 170) through the bus 110, interpret the received instructions, and execute calculation or data processing according to the interpreted instructions.

The memory 130 may store instructions or data received from the processor 120 or the other components (for example, the input/output interface 120, the display 140, the communication interface 160, and the application control module 170) or generated by the processor 120 or the other components. The memory 130, for example, may include programming modules, such as a kernel 131, a middleware 132, an application programming interface (API) 133, or an application 134. Each of the above-mentioned programming modules may be configured with software, firmware, hardware, or a combination of at least two thereof.

The kernel 131 may control or manage system resources (for example, the bus 110, the processor 120, the memory 130, and so on) used for performing operations or functions implemented in the remaining other programming modules, for example, the middleware 132, the API 133, or the application 134. Additionally, the kernel 131 may provide an interface for performing a controlling or managing operation by accessing an individual component of the first electronic device 101 from the middleware 132, the API 133, or the application 134.

The middleware 132 may serve as an intermediary role for exchanging data as the API 133 or the application 134 communicates with the kernel 131. Additionally, in relation to job requests received from the application 134, the middleware 132, for example, may perform a control (for example, scheduling or load balancing) for the job requests by using a method of assigning a priority for using a system resource (for example, the bus 110, the processor 120, the memory 130, and so on) of the first electronic device 101 to at least one application among the applications 134.

The API 133, as an interface for allowing the application 134 to control a function provided from the kernel 131 or the middleware 132, may include at least one interface or function (for example, an instruction) for file control, window control, image processing, or character control.

According to various embodiments of the present disclosure, the application 134 may include short message service (SMS)/multimedia messaging service (MMS) applications, e-mail applications, calendar applications, notification applications, healthcare applications (for example, applications for measuring exercise amount or blood glucose), or environmental information applications (for example, applications for providing pressure, humidity, or temperature information). Additionally or alternatively, the application 134 may be an application relating to information exchange between the first electronic device 101 and an external electronic device (for example, a second electronic device 102). The information exchange related application, for example, may include a notification relay application for relaying specific information to the external device or a device management application for managing the external electronic device (for example, the second electronic device 102).

For example, the notification relay application may have a function for relaying to an external electronic device (for example, the second electronic device 102) notification information occurring from another application (for example, an SMS/MMS application, an e-mail application, a healthcare application, or an environmental information providing application) of the first electronic device 101. Additionally or alternatively, the notification relay application may receive notification information from an external electronic device (for example, the second electronic device 102) notification and may then provide the received notification information to a user. The device management application, for example, may manage (for example, install, delete, or update) at least part of function (turn-on/turn off of the external electronic device itself (or some components) or the brightness (or resolution) adjustment of a display) of an external electronic device (for example, the second electronic device 102 or a server 103) communicating with the first electronic device 101, an application operating in the external electronic device, or a service (for example, a call service or a message service) provided from the external device.

According to various embodiments of the present disclosure, the application 134 may include a specified application according to the property (for example, the type of an electronic device) of the external device (for example, the second electronic device 102). For example, when an external electronic device is an MP3 player, the application 134 may include an application relating to music playback. Similarly, when an external electronic device is a mobile medical device, the application 134 may include an application relating to heath care. According to an embodiment of the present disclosure, the application 134 may include at least one of an application assigned to the first electronic device 101 and an application received from an external electronic device (for example, the second electronic device 102).

According to various embodiments of the present disclosure, the memory 130 may include a buffer 135 for temporarily storing information relating to at least one activity occurring from an execution of the application 134. Herein, an activity may correspond to a certain task unit executed according to an execution of a corresponding application. The buffer 135 may store data relating to a certain number of activities according to an input (hereinafter referred to as a processing input) for processing a user's activity (for example, minimize, move, copy, cut, or terminate). An activity relating to the stored data may be collectively processed by the application control module 170.

The input/output interface 140 may deliver an instruction or data inputted from a user through an input/output device (for example, a sensor, a keyboard, or a touch screen) to the processor 120, the memory 130, the communication interface 160, or the application control module 170 through the bus 110. For example, the input/output interface 140 may provide to the processor 120 data on a user's touch inputted through a touch screen. Additionally, the input/output interface 140 may output, through the input/output device (for example, a speaker or a display), instructions or data received from the processor 120, the memory 130, the communication interface 160, or the application control module 170 through the bus 110. For example, the input/output interface 140 may output voice data processed through the processor 120 to a user through a speaker.

According to various embodiments of the present disclosure, the input/output interface 140 may receive an input for processing an activity from a user. The input/output interface 140 may generate an input signal corresponding to a user's processing input and provide the input signal to the application control module 170. The application control module 170 may determine the processing of an activity stored in the buffer 135 by receiving a corresponding input signal.

The display 150 may display various information (for example, multimedia data or text data) to a user.

The communication interface 160 may connect a communication between the first electronic device 101 and an external device (for example, the second electronic device 102). For example, the communication interface 160 may communicate with the external device in connection to a network 162 through wireless communication or wired communication. The wireless communication, for example, may include at least one of wireless fidelity (WiFi), bluetooth (BT), near field communication (NFC), GPS, and cellular communication (for example, long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM)). The wired communication, for example, may include at least one of a universal serial bus (USB), a high definition multimedia interface (HDMI), recommended standard 232 (RS-232), and a plain old telephone service (POTS).

According to an embodiment of the present disclosure, the network 162 may be telecommunications network. The telecommunications network may include at least one of a computer network, the internet, internet of things, and a telephone network. According to an embodiment of the present disclosure, a protocol (for example, a transport layer protocol, a data link layer protocol, or a physical layer protocol) for communication between the first electronic device 101 and an external device may be supported by at least one of the application 134, the API 133, the middleware 132, the kernel 131, and the communication interface 160.

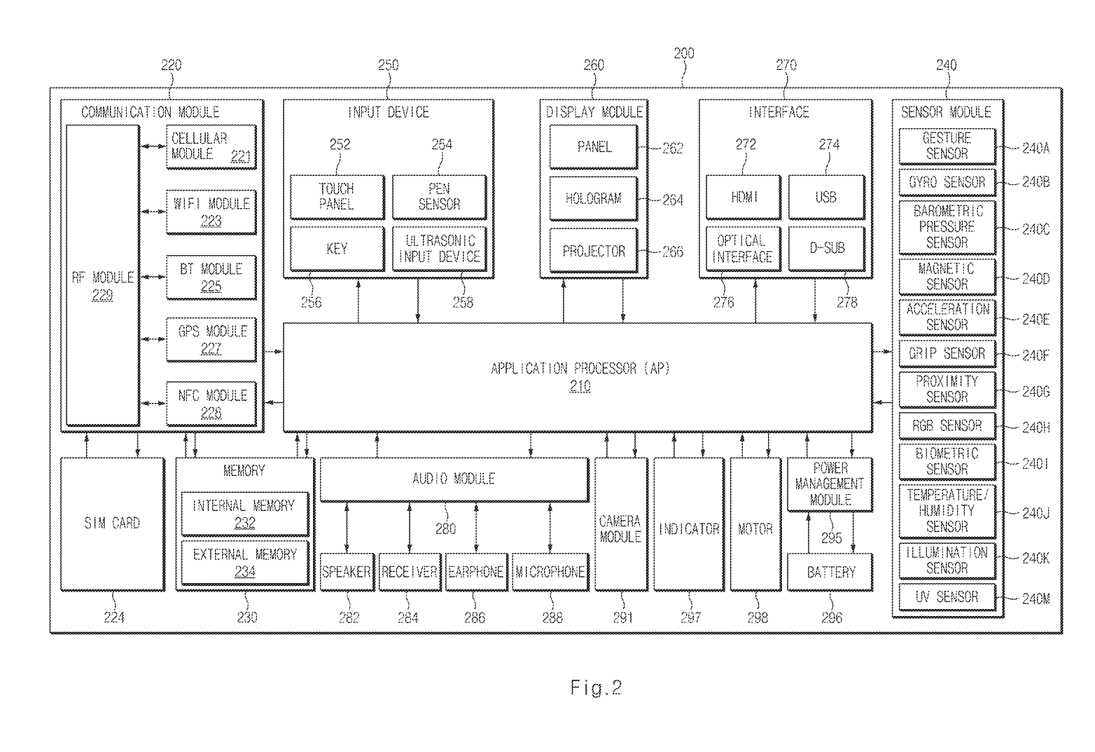

The data processing module 170 may process at least part of information obtained from other components (for example, the processor 120, the memory 130, the input/output interface 140, or the communication interface 160) and provide the at least part of the information to a user through various methods. For example, the application control module 170 may select a certain application from a plurality of applications stored in the memory 130 based on user information received through the input/output interface 140. The selected application may provide a certain service to a user of the first electronic device 101 based on data obtained from the second electronic device 102 including at least one sensor or an external device through the network 162. Additionally, the application control module 170 may select and control a certain application in order to obtain information from various sensors or components in the first electronic device 101 or process information obtained therefrom. A configuration of the first electronic device 101 including various sensors and/or modules will be described with reference to FIG. 2.

According to various embodiments of the present disclosure, the application control module 170 may display on a screen an execution window relating to at least one activity occurring according to the execution of an application. Herein, an activity may correspond to a certain task unit executed according to an execution of a corresponding application. An activity may provide certain information to a user or may generate an execution window to receive a user's processing input. A user may determine the content of each activity or input necessary information for a corresponding activity execution through a corresponding execution window. Each activity may include information on a related execution window (for example, the size of an execution window, the position of an execution window, and configuration information of an execution window).

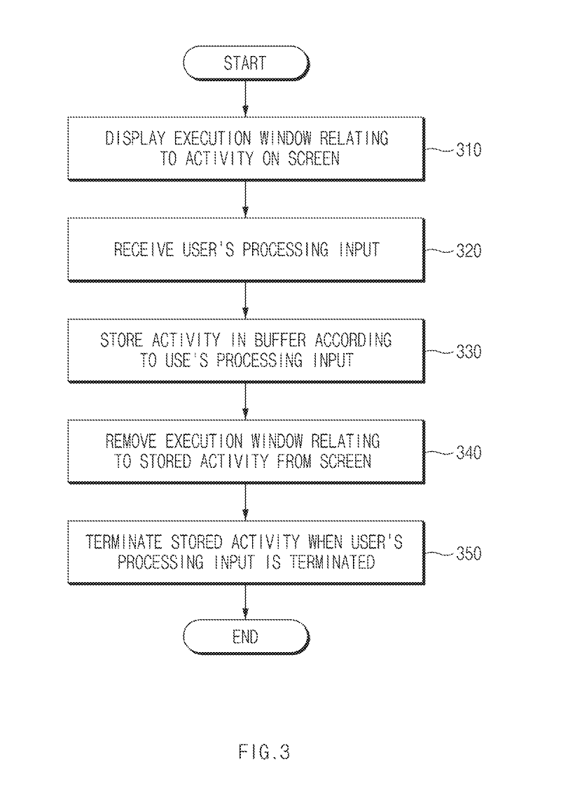

According to various embodiments of the present disclosure, when a plurality of activities is activated, the application control module 170 may store a certain number of activities in the buffer 135 and process them collectively. For example, when five activities are activated according to a certain application execution, the application control module 170 may store three activities in the buffer 135 according to a user's processing input. The application control module 170 may collectively process the stored three activities according to a user's processing input. Detailed operations of the application control module 170 will be described with reference to FIGS. 3 to 9.

FIG. 2 is a block diagram of an electronic device according to various embodiments of the present disclosure. An electronic device 200, for example, may configure all or part of the above-mentioned first electronic device 101 or 102 shown in FIG. 1.

Referring to FIG. 2, the electronic device 200 may include an application processor (AP) 210, a communication module 220, a subscriber identification module (SIM) card 224, a memory 230, a sensor module 240, an input device 250, a display module 260, an interface 270, an audio module 280, a camera module 291, a power management module 295, a battery 296, an indicator 297, and a motor 298.

The AP 210 may control a plurality of hardware or software components connected to the AP 210 and also may perform various data processing and operations with multimedia data by executing an operating system or an application program. The AP 210 may be implemented with a system on chip (SoC), for example. According to an embodiment of the present disclosure, the AP 210 may further include a graphical processing unit (GPU) (not shown).

The communication module 220 (for example, the communication interface 160) may perform data transmission/reception through a communication between other electronic devices (for example, the second electronic device 102) connected to the electronic device 200 (for example, the first electronic device 101) via a network. According to an embodiment of the present disclosure, the communication module 220 may include a cellular module 221, a WiFi module 223, a BT module 225, a GPS module 227, an NFC module 228, and a radio frequency (RF) module 229.

The cellular module 221 may provide voice calls, video calls, text services, or internet services through a communication network (for example, LTE, LTE-A, CDMA, WCDMA, UMTS, WiBro, or GSM). Additionally, the cellular module 221 may perform a distinction and authentication operation on an electronic device in a communication network by using a SIM (for example, the SIM card 224), for example. According to an embodiment of the present disclosure, the cellular module 221 may perform at least part of a function that the AP 210 provides. For example, the cellular module 221 may perform at least part of a multimedia control function.

According to an embodiment of the present disclosure, the cellular module 221 may further include a communication processor (CP). Additionally, the cellular module 221 may be implemented with SoC, for example. As shown in FIG. 2, components, such as the cellular module 221 (for example, a CP), the memory 230, or the power management module 295 are separated from the AP 210, but according to an embodiment of the present disclosure, the AP 210 may be implemented including some of the above-mentioned components (for example, the cellular module 221).

According to an embodiment of the present disclosure, the AP 210 or the cellular module 221 (for example, a CP) may load instructions or data, which are received from a nonvolatile memory or at least one of other components connected thereto, into a volatile memory and then may process them. Furthermore, the AP 210 or the cellular module 221 may store data received from or generated by at least one of other components in a nonvolatile memory.

Each of the WiFi module 223, the BT module 225, the GPS module 227, and the NFC module 228 may include a processor for processing data transmitted/received through a corresponding module. Although the cellular module 221, the WiFi module 223, the BT module 225, the GPS module 227, and the NFC module 228 are shown as separate blocks in FIG. 2, according to an embodiment of the present disclosure, some (for example, at least two) of the cellular module 221, the WiFi module 223, the BT module 225, the GPS module 227, and the NFC module 228 may be included in one integrated chip (IC) or an IC package. For example, at least some (for example, a CP corresponding to the cellular module 221 and a WiFi processor corresponding to the WiFi module 223) of processors respectively corresponding to the cellular module 221, the WiFi module 223, the BT module 225, the GPS module 227, and the NFC module 228 may be implemented with one SoC.

The RF module 229 may be responsible for data transmission, for example, the transmission of an RF signal. Although not shown in the drawings, the RF module 229 may include a transceiver, a power amp module (PAM), a frequency filter, or a low noise amplifier (LNA). Additionally, the RF module 229 may further include components for transmitting/receiving electromagnetic waves on a free space in a wireless communication, for example, conductors or conducting wires. Although the cellular module 221, the WiFi module 223, the BT module 225, the GPS module 227, and the NFC module 228 share one RF module 229 shown in FIG. 2, according to an embodiment of the present disclosure, at least one of the cellular module 221, the WiFi module 223, the BT module 225, the GPS module 227, and the NFC module 228 may perform the transmission of an RF signal through an additional RF module.

The SIM card 224 may be a card including a SIM and may be inserted into a slot formed at a specific position of an electronic device. The SIM card 224 may include unique identification information (for example, an integrated circuit card identifier (ICCID)) or subscriber information (for example, an international mobile subscriber identity (IMSI)).

The memory 230 (for example, the memory 130) may include an internal memory 232 or an external memory 234. The internal memory 232 may include at least one of a volatile memory (for example, dynamic random access memory (DRAM), static RAM (SRAM), synchronous dynamic RAM (SDRAM)) and a non-volatile memory (for example, one time programmable read only memory (OTPROM), programmable ROM (PROM), erasable and programmable ROM (EPROM), electrically erasable and programmable ROM (EEPROM), mask ROM, flash ROM, not and (NAND) flash memory, and not or (NOR) flash memory).

According to an embodiment of the present disclosure, the internal memory 232 may be a solid state drive (SSD). The external memory 234 may further include flash drive, for example, compact flash (CF), secure digital (SD), micro-SD, Mini-SD, extreme digital (xD), or a memorystick. The external memory 234 may be functionally connected to the electronic device 200 through various interfaces. According to an embodiment of the present disclosure, the electronic device 200 may further include a storage device (or a storage medium), such as a hard drive.

The sensor module 240 measures physical quantities or detects an operating state of the electronic device 200, thereby converting the measured or detected information into electrical signals. The sensor module 240 may include at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 2401, a temperature/humidity sensor 240J, an illumination sensor 240K, and an ultraviolet (UV) sensor 240M. Additionally or alternatively, the sensor module 240 may include an E-nose sensor (not shown), an electromyography (EMG) sensor, an electroencephalogram (EEG) sensor (not shown), an electrocardiogram (ECG) sensor (not shown), an infrared (IR) sensor (not shown), an iris sensor (not shown), or a fingerprint sensor (not shown). The sensor module 240 may further include a control circuit for controlling at least one sensor therein.

The input device 250 may include a touch panel 252, a (digital) pen sensor 254, a key 256, or an ultrasonic input device 258. The touch panel 252 may recognize a touch input through at least one of capacitive, resistive, infrared, or ultrasonic methods, for example. Additionally, the touch panel 252 may further include a control circuit. In the case of the capacitive method, both direct touch and proximity recognition are possible. The touch panel 252 may further include a tactile layer. In this case, the touch panel 252 may provide a tactile response to a user.

The (digital) pen sensor 254 may be implemented through a method similar or identical to that of receiving a user's touch input or an additional sheet for recognition. The key 256 may include a physical button, an optical key, or a keypad, for example. The ultrasonic input device 258, as a device determining data by detecting sound waves through a microphone (for example, a microphone 288) in the electronic device 200, may provide wireless recognition through an input tool generating ultrasonic signals. According to an embodiment of the present disclosure, the electronic device 200 may receive a user's processing input from an external device (for example, a computer or a server) connected to the electronic device 200 through the communication module 220.

The display module 260 (for example, the display 150) may include a panel 262, a hologram device 264, or a projector 266. The panel 262 may include a liquid-crystal display (LCD) or an active-matrix organic light-emitting diode (AM-OLED). The panel 262 may be implemented to be flexible, transparent, or wearable, for example. The panel 262 and the touch panel 252 may be configured with one module. The hologram 264 may show three-dimensional images in the air by using the interference of light. The projector 266 may display an image by projecting light on a screen. The screen, for example, may be placed inside or outside the electronic device 200. According to an embodiment of the present disclosure, the display module 260 may further include a control circuit for controlling the panel 262, the hologram device 264, or the projector 266.

The interface 270 may include an HDMI 272, a USB 274, an optical interface 276, or a D-subminiature (sub) 278 for example. The interface 270, for example, may be included in the communication interface 160 shown in FIG. 1. Additionally or alternatively, the interface 270 may include a mobile high-definition link (MHL) interface, an SD card/multi-media card (MMC) interface, or an infrared data association (IrDA) standard interface.

The audio module 280 may convert sound into electrical signals and convert electrical signals into sounds. At least some components of the audio module 280, for example, may be included in the input/output interface 140 shown in FIG. 1. The audio module 280 may process sound information inputted/outputted through a speaker 282, a receiver 284, an earphone 286, or the microphone 288.

The camera module 291, as a device for capturing a still image and a video, may include at least one image sensor (for example, a front sensor or a rear sensor), a lens (not shown), an image signal processor (ISP) (not shown), or a flash (not shown) (for example, an LED or a xenon lamp).

The power management module 295 may manage the power of the electronic device 200. Although not shown in the drawings, the power management module 295 may include a power management IC (PMIC), a charger IC, or a battery or fuel gauge, for example.

The PMIC may be built in an IC or an SoC semiconductor, for example. A charging method may be classified into a wired method and a wireless method. The charger IC may charge a battery and may prevent overvoltage or overcurrent flow from a charger. According to an embodiment of the present disclosure, the charger IC may include a charger IC for at least one of a wired charging method and a wireless charging method. As the wireless charging method, for example, there is a magnetic resonance method, a magnetic induction method, or an electromagnetic method. An additional circuit for wireless charging, for example, a circuit, such as a coil loop, a resonant circuit, or a rectifier circuit, may be added.

The battery gauge may measure the remaining amount of the battery 296, or a voltage, current, or temperature thereof during charging. The battery 296 may store or generate electricity and may supply power to the electronic device 200 by using the stored or generated electricity. The battery 296, for example, may include a rechargeable battery or a solar battery.

The indicator 297 may display a specific state of the electronic device 200 or part thereof (for example, the AP 210), for example, a booting state, a message state, or a charging state. The motor 298 may convert electrical signals into mechanical vibration. Although not shown in the drawings, the electronic device 200 may include a processing device (for example, a GPU) for mobile TV support. A processing device for mobile TV support may process media data according to the standards, such as digital multimedia broadcasting (DMB), digital video broadcasting (DVB), or media FLOW.

According to various embodiments of the present disclosure, an electronic device may include an application control module and a buffer. The application control module may display on a screen at least one execution window according to the execution of an application and the buffer may store an activity relating to an execution window of a range determined according to a user's processing input. The application control module may remove an execution window corresponding to the stored activity from the screen and may terminate the stored activity when the user's processing input is completed.

FIG. 3 is a flowchart illustrating an activity processing method according to various embodiments of the present disclosure.

Referring to FIG. 3, the application control module 170 may display an execution window (hereinafter referred to as an activity execution window) relating to an activity occurring according to the execution of an application in operation 310. For example, in the case of a diary application, the application control module 170 may display on a screen an activity execution window displaying a user's entire this week schedule. When a user press a schedule add button, the application control module 170 may display an activity execution window displaying this month's schedule. When a user selects a date from the calendar, the application control module 170 may generate an activity execution window for inputting a time. The application control module 170 may display various activity execution windows for providing information to a user or receiving a user's processing input according to an application execution. According to the execution of an application, the activity execution window may be continuously stacked on the screen.

In operation 320, the input/output interface 140 may receive a user's processing input for processing an activity. The processing input may correspond to a certain operation (for example, a specified button press or a specified position touch on a screen) for processing an activity.

When a user performs the processing input, the input/output interface 140 may provide information on the processing input to the application control module 170. According to various embodiments of the present disclosure, the processing input may change continuously in a specified direction (for example, a direction from the bottom to the top of a screen). The input/output interface 140 may continuously provide information on a change of the processing input to the application control module 170.

In operation 330, the application control module 170 may store an activity relating to an execution window displayed on the screen, in the buffer 135, according to a user's processing input. When a change of a user's processing input is relatively large, the application control module 170 may store a plurality of activities corresponding to the change in the buffer 135. On the other hand, when a change of a user's processing input is relatively small, the application control module 170 may store a small number of activities corresponding to the change in the buffer 135.

In operation 340, the application control module 170 may remove an activity execution window relating to a stored activity from the screen of the electronic device 101. The application control module 170 may gradually remove an activity execution window through execution window size reduction or transparent increase while the activity execution window is removed. A user may determine an activity processed by a user's processing input through a reduced or transparent-processed activity execution window.

In operation 350, when a user's processing input is completed (for example, when a touch input is completed), the application control module 170 may terminate an activity stored in the buffer 135. A user may not process each activity execution window separately and may collectively process a plurality of execution windows in a desired range through only one input.

According to various embodiments of the present disclosure, the application control module 170 may collectively process an activity stored in the buffer 135 so that the application control module 170 improves a user's application usage convenience. For example, the application control module 170 may perform a task, such as collectively minimizing, moving, copying, cutting, or terminating an activity stored in the buffer 135. A user may not process each activity repeatedly and may collectively process a desired number of activities.

According to various embodiments of the present disclosure, the application control module 170 may store identification information of an activity in the buffer 135 according to a user's processing input. The application control module 170 may collectively process a related activity based on the stored identification information. For example, when identification information of first to fifth activities are a1 to a5, respectively, a1 to a3 that are identification information on the respective first to third activities may be stored in the buffer 135 according to a user's processing input. When a user's processing input is completed (for example, when a touch input is completed), the application control module 170 may perform a task, such as collectively minimizing, moving, copying, terminating, and the like, the first to third activities relating to the identification information a1 to a3. According to various embodiments of the present disclosure, the identification information may be an activity function identifier or an activity execution window identifier.

Hereinafter, a process for storing and processing an activity is mainly described but the present disclosure is not limited thereto. For example, this may be applied to a process for storing identification information of an activity and processing an activity relating to the stored identification information.

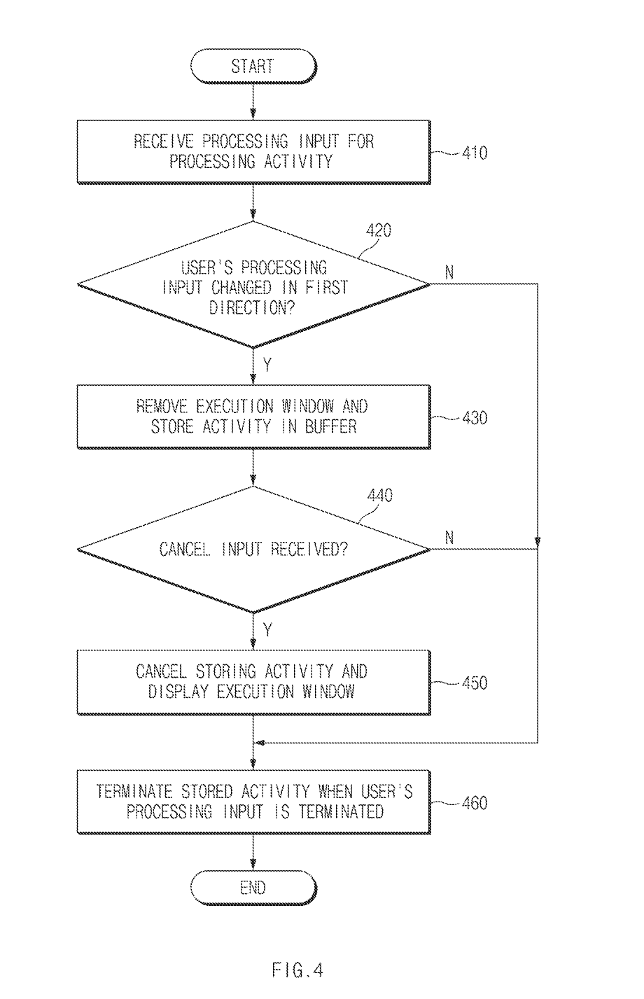

FIG. 4 is a flowchart illustrating a method of terminating an activity according to various embodiments of the present disclosure.

Referring to FIG. 4, the input/output interface 140 may receive an input (for example, a specified button press or a specified position touch on a screen) for starting the processing of an activity from a user in operation 410. The input/output interface 140 may generate an input signal corresponding to a user's processing input and provide the input signal to the application control module 170. The input may change continuously in a specified direction (for example, a direction from the bottom to the top of a screen). The input/output interface 140 may continuously provide information on a change of the input to the application control module 170.

In operation 420, the application control module 170 may determine whether a user's processing input is changed in a first direction (for example, a direction from the bottom to the top of a screen). The first direction may be a certain direction for storing an activity in the buffer 135.

In operation 430, when a user's processing input is changed in the first direction, the application control module 170 may sequentially store an activity in the buffer 135 in the display order of activity execution windows displayed on the screen according to a change degree (for example, a swiped distance) of the user's processing input. For example, each time a user's touch input is moved by 1 cm in the first direction, the application control module 170 may store an activity relating to an activity execution window displayed on the screen in the buffer 135 one by one. The application control module 170 may sequentially remove an execution window relating to the stored activity from the screen.

In operation 440, the application control module 170 may determine whether a user's cancel input is received. A user's cancel input may be an input for canceling the storage of an activity stored in the buffer 135 (or restoring an execution window). The cancel input may correspond to an input of a second direction (for example, a direction from the top to the bottom of a screen) different from the first direction. According to various embodiments of the present disclosure, the cancel input may be an input that is continuous to a user's processing input for removing an activity. For example, as a touch input is completed while a user maintains the touch input in the first direction, the application control module 170 may terminate an activity stored in the buffer 135. On the other hand, as a touch input is moved in the second direction opposite to the first direction while a user maintains the touch, the application control module 170 may cancel activity saving and restore an activity execution window.

In operation 450, if there is a user's cancel input, the application control module 170 may sequentially remove an activity stored in the buffer 135 from the buffer 135 according to a change degree of the cancel input. For example, each time a user's cancel input is moved by 1 cm in the second direction, the application control module 170 may remove an activity stored in the buffer 135 from the buffer 135 one by one. The application control module 170 may sequentially display execution windows relating to activities removed from the buffer 135 on the screen in the reverse order of the order in which they are removed. According to an embodiment of the present disclosure, the application control module 170 may remove the last stored activity firstly according to a user's cancel input. For example, when first to third activities are stored sequentially, the application control module 170 removes the third activity firstly and may remove the second activity according a change of a user's cancel input. The first activity may be removed lastly.

According to various embodiments of the present disclosure, the application control module 170 may receive an input for storing an activity again after receiving a cancel input. For example, after receiving a cancel input in the second direction (for example, a direction from the top to the bottom of a screen), the control module 170 may receive a user's processing input in the first direction again (for example, a direction from the bottom to the top of a screen). In this case, the application control module 170 may stop the removal process of the stored activity and may additionally perform a process for storing an activity in the buffer 135. A user may determine the number of activities to be processed as changing an input in the first direction or the second direction.

In operation 460, when a user's processing input is completed (for example, when a touch input is completed), the application control module 170 may terminate a stored activity. The application control module 170 may collectively terminate activities stored in the buffer 135 so that this resolves an inconvenience of separately processing each activity.

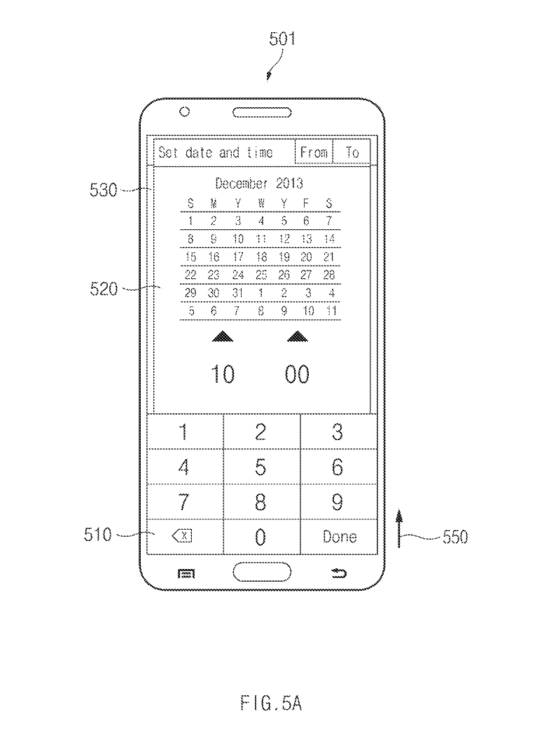

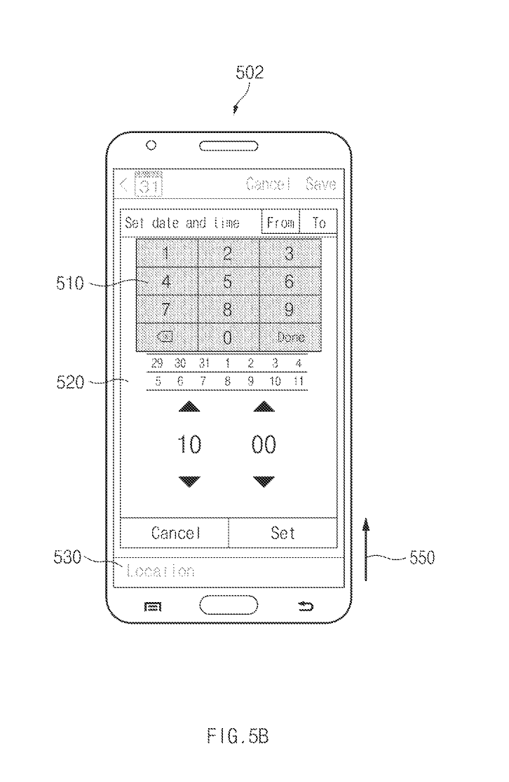

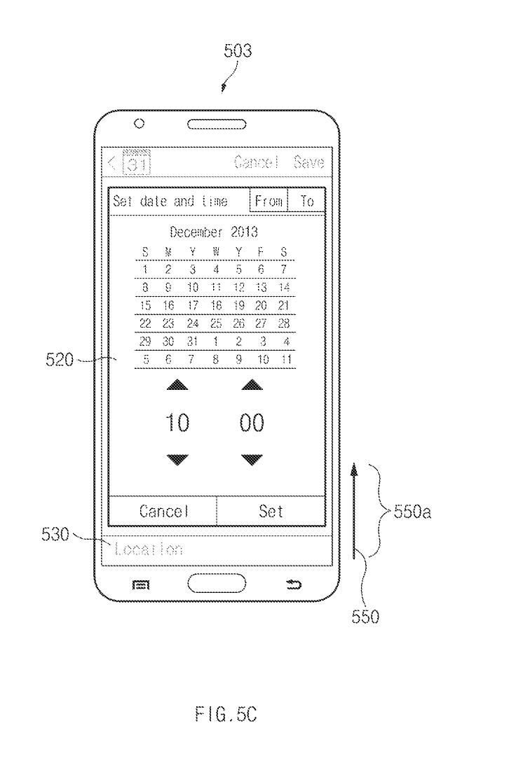

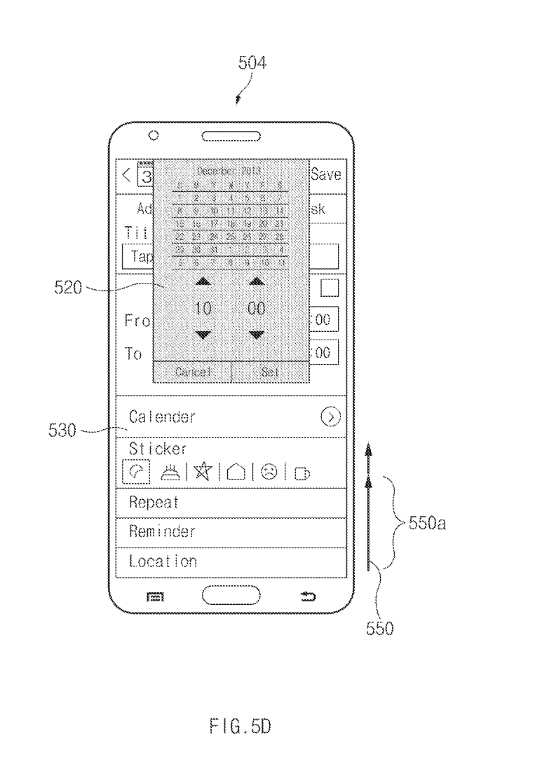

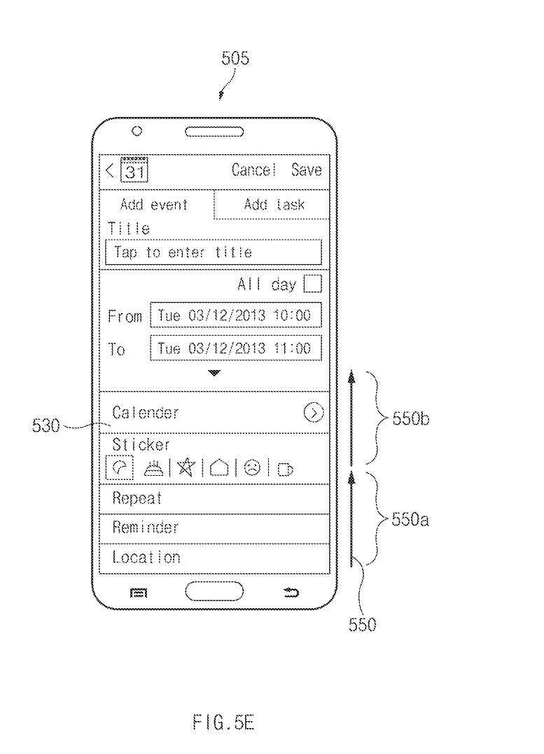

FIGS. 5A, 5B, 5C, 5D, and 5E are views of a screen illustrating a removal process of an activity execution window according to various embodiments of the present disclosure.

Referring to FIG. 5A, a screen 501 is a screen receiving a user's processing input for starting the processing of three activities (first to third activities). Referring to the screen 501, first to third activity execution windows 510 to 530 respectively relating to the first to third activities may be sequentially displayed on the screen of the electronic device 101. The first activity execution window 510 may be disposed at the upper most layer on the screen. The second activity execution window 520 may be displayed below the first activity execution window 510. The third activity execution window 530 may be displayed below the second activity execution window 520. When a user's processing input 550 starts, the application control module 170 may start a process for storing a first activity in the buffer 135.

Referring to FIG. 5B, a screen 502 is a screen representing a removal process of the first activity execution window 510. Referring to the screen 502, the application control module 170 may move the position of the first activity execution window 510 to the screen upper end as the user's processing input 550 moves in the first direction (for example, a direction from the bottom to the top of a screen. In this case, the application control module 170 may provide an effect of gradually reducing the size of the first activity execution window 510 or gradually increasing the transparency thereof. For example, the application control module 170 may sequentially increase the transparency of the first activity execution window 510 from 0% to 100% to provide a disappearing effect to a user.

Referring to FIG. 5C, a screen 503 is a screen representing a removal completion of the first activity execution window 510. Referring to the screen 503, when the user's processing input 550 is gradually moved in the first direction by a certain range 550a, the application control module 170 may set the first activity execution window 510 not to be displayed on the screen. For example, the application control module 170 may set that the transparency of an execution window is gradually increased at a point where a user's processing input starts and becomes 100% at a point where a critical value 550a starts. As another example, the application control module 170 may set that an execution window starts moving to a screen outside direction and disappears completely outside the screen at a point where the critical value 550a starts.

According to various embodiments of the present disclosure, the application control module 170 may store in the buffer 135 an activity relating to the first activity execution window 510 at a point where the first activity execution window 510 is removed.

After the user's processing input 550 reaches the critical value 550a, until the next critical value 550b, the second activity execution window 520 and the third activity execution window 530 remain on the screen.

Referring to FIG. 5D, a screen 504 is a screen representing a removal process of the second activity execution window 520. Referring to the screen 504, the second activity execution window 520 may be removed in a similar manner of removing the first activity execution window 510. As the user's processing input 550 is moved additionally in the first direction (for example, a direction from the bottom to the top of a screen) at a point where the first activity is stored, the application control module 170 may move the position of the second activity execution window 520 to the screen upper end. In this case, the application control module 170 may provide an effect of gradually reducing the size of the second activity execution window 520 or gradually increasing the transparency thereof.

Referring to FIG. 5E, a screen 505 is a screen representing a removal completion of the second activity execution window 520. Referring to the screen 505, when the user's processing input 550 is gradually moved in the first direction by a certain range 550b and is moved additionally, the application control module 170 may set the second activity execution window 520 not to be displayed on the screen. The third activity execution window 530 remains on the screen. Although not shown in FIGS. 5A, 5B, 5C, 5D, and 5E, the third activity execution window 530 may be removed through a similar manner of removing the second activity execution window 520.

According to various embodiments of the present disclosure, when the user's processing input is completed (for example, when a touch input is completed), the application control module 170 may collectively terminate an activity stored in the buffer 135. When a user moves a touch input by a certain range and terminates the touch input, the application control module 170 may collectively terminate an activity stored in the buffer 135. According to an embodiment of the present disclosure, when a user terminates a touch input, the application control module 170 may generate a pop-up screen for asking the processing of an activity stored in the buffer 135. The application control module 170 may allow a user to select a task, such as minimizing or terminating an activity stored in the buffer 135 through a pop-up screen.

According to various embodiments of the present disclosure, when a user selects all activity execution windows relating to an application in execution, the application control module 170 may automatically terminate the application or may generate a pop-up screen for asking the termination of the application.

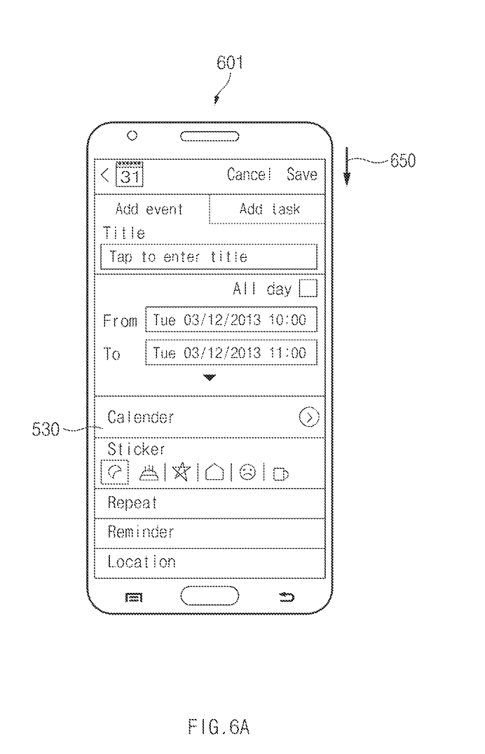

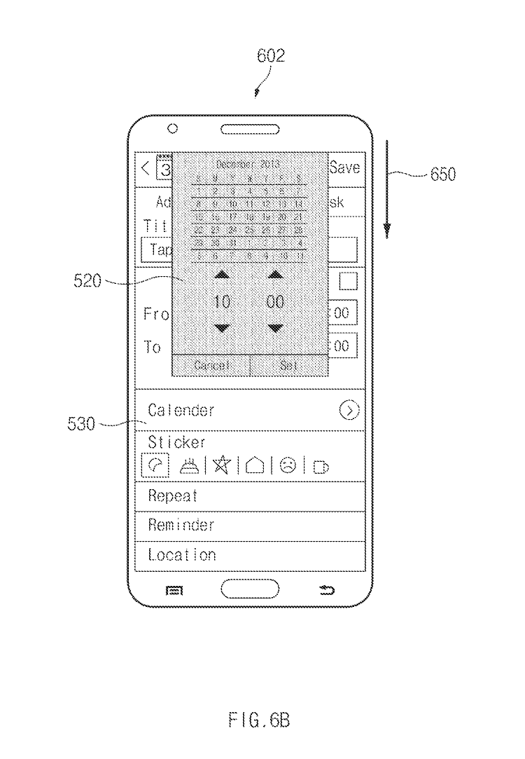

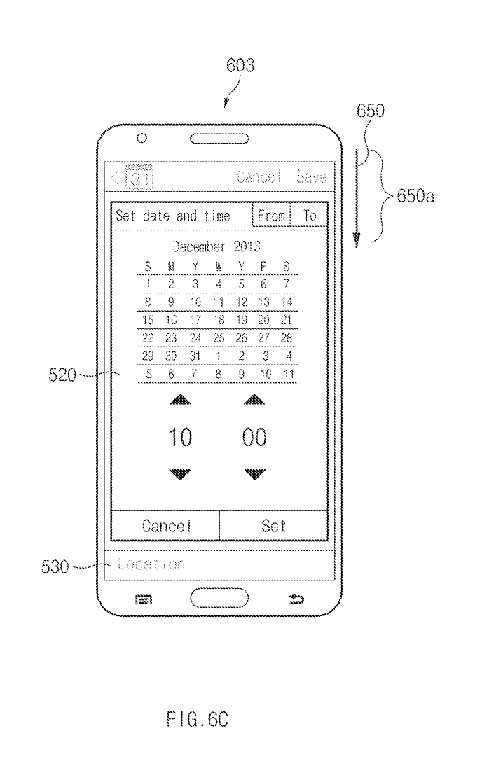

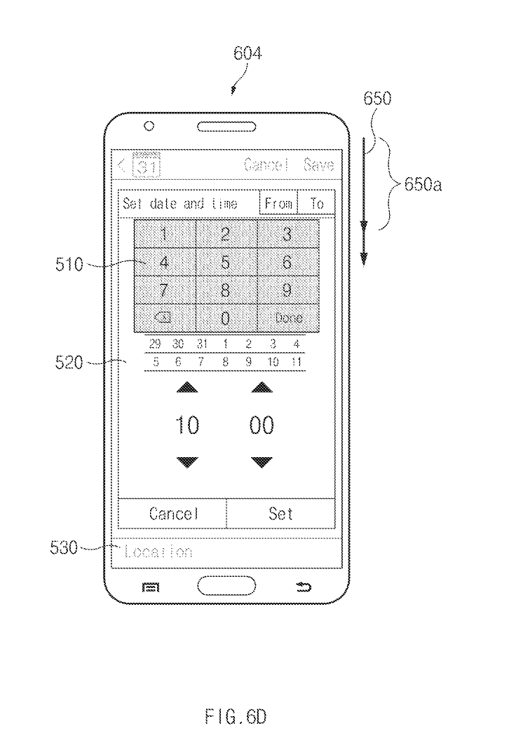

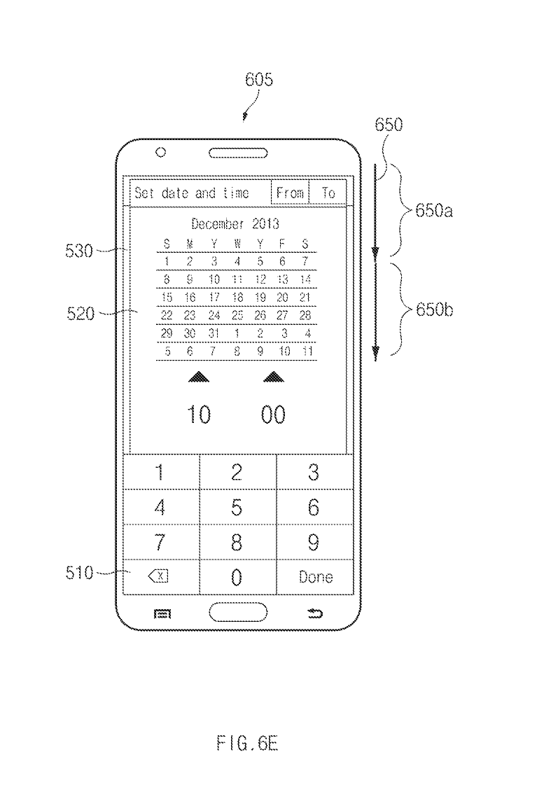

FIGS. 6A, 6B, 6C, 6D, and 6E are views of a screen illustrating a restoration process of an activity execution window according to various embodiments of the present disclosure.

Referring to FIG. 6A, a screen 601 is a screen receiving a cancel input for the restoration of an activity execution window. Referring to the screen 601, while a first activity or a second activity is stored in the buffer 135, a user may move an input in the second direction (for example, a direction from the top to the bottom of a screen) that is opposite to the first direction without releasing the touch input. The application control module 170 may start a restoration process for the lastly removed second activity execution window 520.

Referring to FIG. 6B, a screen 602 is a screen representing a restoration process of the second activity execution window 520. Referring to the screen 602, as the user's cancel input 650 is moved in the second direction (for example, a direction from the top to the bottom of a screen), the application control module 170 may move the position of the second activity execution window 520 to the original position at the screen upper end. In this case, the application control module 170 may provide an effect of gradually increasing the size of the second activity execution window 520 or gradually reducing the transparency thereof. For example, the application control module 170 may sequentially reduce the transparency of the second activity execution window 520 from 100% to 0% to provide an execution window disappearing effect to a user.

Referring to FIG. 6C, a screen 603 is a screen representing a restoration completion of the second activity execution window 520. Referring to the screen 603, when a user's cancel input 650 is gradually moved in the second direction by a certain range 650a, the application control module 170 may return the second activity execution window 520 to the original position.

According to an embodiment of the present disclosure, when the user's cancel input is completed (for example, when a touch input is completed), the application control module 170 may collectively terminate an activity stored in the buffer 135 at a point where the cancel input 650 is completed. For example, if a user returns the second activity execution window 520 and terminates a touch input before the first activity execution window 510 returns, the application control module 170 may terminate a first activity stored in the buffer 135.

Referring to FIG. 6D, a screen 604 is a screen representing a restoration process of the first activity execution window 510. Referring to the screen 604, the first activity execution window 510 may be restored in a similar manner of restoring the second activity execution window 520. As the user's cancel input 650 is moved additionally in the second direction (for example, a direction from the top to the bottom of a screen) at a point where the second activity window 520 is restored, the application control module 170 may move the position of the first activity execution window 510 to the original position at the screen upper end. In this case, the application control module 170 may provide an effect of gradually increasing the size of the first activity execution window 510 or gradually reducing the transparency thereof. For example, the application control module 170 may sequentially reduce the transparency of the first activity execution window 510 from 100% to 0% to provide an execution window appearing effect to a user.

Referring to FIG. 6E, a screen 605 is a screen representing a restoration completion of the first activity execution window 510. Referring to the screen 605, when a user's cancel input 650 is gradually moved in the second direction and is additionally moved by a certain range 650b, the application control module 170 may return the first activity execution window 510 to the original position.

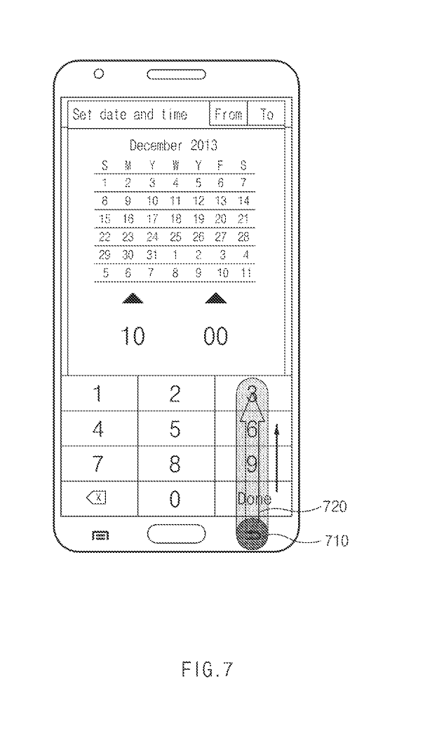

FIG. 7 is a view of a screen illustrating an activity storing process using a button of an electronic device according to an embodiment of the present disclosure.

Referring to FIG. 7, when an input for at least one button of the electronic device 101 occurs, the application control module 170 may start storing an activity. The button may be implemented using a touch key or a physical key. For example, when a back button 710 is pressed, the application control module 170 may start processing an activity.

According to various embodiments of the present disclosure, if there are at least one button of the electronic device 101 and a touch input for an edge point on a screen adjacent to the button (hereinafter, a button and touch input), the application control module 170 may be set to start storing an activity according to the button and touch input. In the button and touch input, a button input and a touch input may start at the same time or within a certain time range. According to an embodiment of the present disclosure, the application control module 170 may receive an input for a button (for example, a back button 710) disposed at the front of the user's electronic device 101 and a touch input for an edge point 720 on a screen adjacent to the button at the same time or within a certain range. The application control module 170 may start processing an activity according to the button and touch input.

When a user moves the input in the first direction (for example, a direction from the bottom to the top of a screen) while maintaining a touch state after a button and touch input, the application control module 170 may sequentially process an activity according to a movement of the input. A range of an activity to be processed may be determined according to a movement distance of the input, and when the input is completed (for example, a touch input is completed), stored activities may be completed collectively.

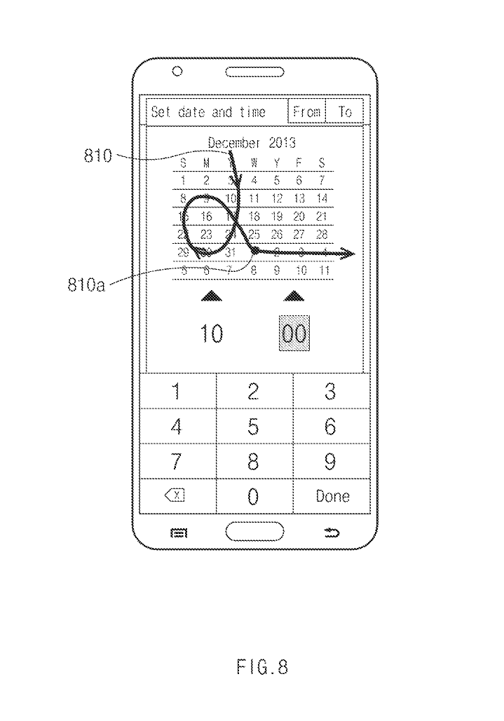

FIG. 8 is a view of a screen illustrating an activity storing process using a gesture according to an embodiment of the present disclosure.

Referring to FIG. 8, when a gesture 810 of a specific pattern is received on a touch screen, the application control module 170 may start storing an activity according to the input. For example, when the gesture 810 of an alpha form is received on a touch screen, the application control module 170 may start storing an activity. When a user moves the input in the first direction (for example, a direction from the left to the right of a screen) at a point 810a where the gesture 810 is completed, the application control module 170 may sequentially store activities in the buffer 135. A range of an activity to be processed may be determined according to a movement degree of the input, and when the input is completed (for example, a touch input is completed), stored activities may be completed collectively.

According to various embodiments of the present disclosure, the application control module 170 may receive recognition information on a user through the sensor module 240. After comparing the recognition information with a certain reference value, if the recognition information is greater than the reference value, the application control module 170 may determine the recognition information as an input for activity storage. For example, if recognizing a user's specific operation through the gesture sensor 240A of the sensor module 240, the application control module 170 may start storing an activity through the operation.

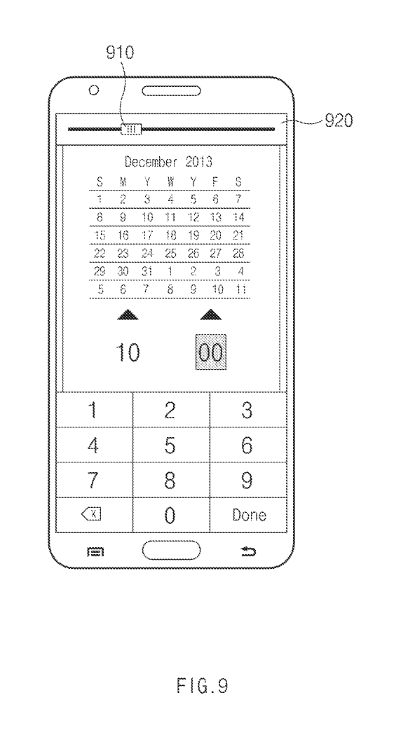

FIG. 9 is a view of a screen illustrating an activity storing process using a moving bar according to an embodiment of the present disclosure.

Referring to FIG. 9, when more than a certain number of activity execution windows are displayed on a screen, the application control module 170 may generate a moving bar or a moving area 920 at a specific portion on the screen. For example, when more than three activity execution windows are displayed on the screen, the application control module 170 may generate the moving bar 910 or the moving area at the screen upper end. When a user positions the moving bar 910 at a first point (for example, the left end) by default and moves the moving bar 910 in the direction of a second point (for example, the right end), the application control module 170 may store an activity relating to an activity execution window displayed on the screen in the buffer 135 according to a movement degree. On the other hand, when a user moves the moving bar 910 in the direction from the second point (for example, the right end) to the first point (for example, the left end), the application control module 170 may cancel storing an activity according to a movement degree of the moving bar 910. When a movement of the moving bar 910 is completed (for example, a touch input is completed), stored activities may be completed collectively.

According to various embodiments of the present disclosure, an activity processing method may include displaying on a screen an execution window relating to at least one activity occurring according to the execution of an application, receiving a user's processing input, storing in a buffer the activity in a range determined according to the user's processing input, removing an execution window relating to the stored activity from the screen, and terminating the stored activity when the user's processing input is completed.

According to various embodiments of the present disclosure, the displaying of the execution window on the screen may include, when at least two execution windows for at least one application occur, sequentially displaying a corresponding execution window on a screen.

According to various embodiments of the present disclosure, the storing of the activity in the buffer may include determining the type or number of activities stored based on at least one of the type or movement range of the user's processing input. The storing of the activity in the buffer may include proportionally determining the number of the stored activities according to the number of entire execution windows displayed on the screen or the number of executed applications. The storing of the activity in the buffer may include storing a related activity in the buffer in the reverse order of the order in which the execution window is displayed on the screen.

According to various embodiments of the present disclosure, the removing of the execution window from the screen may include providing an effect of increasing or decreasing the transparency of the execution window according to a change of the user's processing input. The terminating of the stored activity may include removing the stored activity from the buffer.

According to various embodiments of the present disclosure, the user's processing input may include an input for at least one fixed or dynamic button of the electronic device. The user's processing input may include a touch input for a point adjacent to the button or a touch input for an entire screen including an edge of the screen. The touch input may include a touch input moving from an edge point of the screen to a specified direction. The user's processing input may include a gesture input of a specified pattern.

According to various embodiments of the present disclosure, the user's processing input may include information on a user detected by a sensor of the electronic device. The user's processing input may include an input moving a moving bar displayed when the number of execution windows displayed on the screen of the electronic device is greater than a certain number.

According to various embodiments of the present disclosure, an application control method of an electronic device may include displaying on a screen each execution window for an application in at least two applications executed in the electronic device, storing a corresponding application in a buffer according to the order in which the applications are executed, receiving a user's processing input, removing an execution window of the stored application according to the user's processing input (herein, the removing of the execution window may include differently setting the type or number of execution windows removed according to the type of a user's processing input inputted to a screen or an area where an input is applied), terminating an application of the removed execution window, and deleting the completed application from the buffer.

As mentioned above, various embodiments of the present disclosure may collectively process a determined number of activities according to a user's processing input.

Various embodiments of the present disclosure may efficiently manage a plurality of activities by allowing a user to directly adjust the number of activities to be processed.

Various embodiments of the present disclosure may provide various effects for an activity to be processed.

Each of the above-mentioned components of the electronic device according to various embodiments of the present disclosure may be configured with at least one component and the name of a corresponding component may vary according to the kind of an electronic device. An electronic device according to various embodiments of the present disclosure may include at least one of the above-mentioned components, may not include some of the above-mentioned components, or may further include another component. Additionally, some of components in an electronic device according to various embodiments of the present disclosure are configured as one entity, so that functions of previous corresponding components are performed identically.

The term “module” used in various embodiments of the present disclosure, for example, may mean a unit including a combination of at least one of hardware, software, and firmware. The term “module” and the term “unit”, “logic”, “logical block”, “component”, or “circuit” may be interchangeably used. A “module” may be a minimum unit or part of an integrally configured component. A “module” may be a minimum unit performing at least one function or part thereof. A “module” may be implemented mechanically or electronically. For example, “module” according to various embodiments of the present disclosure may include at least one of an application-specific integrated circuit (ASIC) chip performing certain operations, field-programmable gate arrays (FPGAs), or a programmable-logic device, all of which are known or to be developed in the future.

According to various embodiments of the present disclosure, at least part of a device (for example, modules or functions thereof) or a method (for example, operations) according to this disclosure, for example, as in a form of a programming module, may be implemented using an instruction stored in computer-readable storage media. When at least one processor (for example, the processor 610) executes an instruction, the at least one processor may perform a function corresponding to the instruction. The non-transitory computer-readable storage media may include the memory 630, for example. At least part of a programming module may be implemented (for example, executed) by the processor 610, for example. At least part of a programming module may include a module, a program, a routine, sets of instructions, or a process to perform at least one function, for example.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

In relation to a non-transitory computer-readable storage medium having instructions for controlling operations of an electronic device, the instructions may perform displaying on a screen an execution window relating to at least one activity occurring according to the execution of an application, receiving a user's processing input, storing in a buffer the activity in a range determined according to the user's processing input, removing an execution window relating to the stored activity from the screen, and terminating the stored activity when the user's processing input is completed.

A module or a programming module according to various embodiments of the present disclosure may include at least one of the above-mentioned components, may not include some of the above-mentioned components, or may further include another component. Operations performed by a module, a programming module, or other components according to various embodiments of the present disclosure may be executed through a sequential, parallel, repetitive or heuristic method. Additionally, some operations may be executed in a different order or may be omitted. Or, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An activity processing method in an electronic device, the method comprising:
displaying on a screen an execution window relating to at least one activity occurring according to an execution of an application;
receiving a processing input of a user;
storing in a buffer the at least one activity corresponding to a range determined by the processing input;
removing an execution window relating to the at least one stored activity from the screen; and
terminating the at least one stored activity.

2. The method of claim 1, wherein the displaying of the executing window on the screen comprises, when at least two execution windows occur for one application, sequentially displaying a corresponding execution window.

3. The method of claim 1, wherein the storing of the at least one activity in the buffer comprises determining a type or a number of activities stored based on at least one of a type or a movement range of the processing input.

4. The method of claim 1, wherein the storing of the at least one activity in the buffer comprises proportionally determining a number of the stored activities according to a number of entire execution windows displayed on the screen or a number of applications in execution.

5. The method of claim 1, wherein the storing of the at least one activity in the buffer comprises storing related activities in the buffer in a reverse order of an order in which the execution window is displayed on a screen.

6. The method of claim 1, wherein the removing of the execution window from the screen comprises providing an effect of increasing or decreasing a transparency of the execution window according to a change of the processing input.

7. The method of claim 1, wherein the terminating of the at least one stored activity comprises removing the at least one stored activity from the buffer.

8. The method of claim 1, wherein the processing input comprises an input for at least one fixed or dynamic button of the electronic device.

9. The method of claim 8, wherein the processing input comprises a touch input for a point adjacent to the button or a touch input for an entire screen including an edge of a screen.

10. The method of claim 9, wherein the touch input comprises a touch input moving from an edge point of the screen to a specified direction.

11. The method of claim 1, wherein the processing input comprises a gesture input of a specified pattern.

12. The method of claim 1, wherein the processing input comprises information on a user detected by a sensor of the electronic device.

13. The method of claim 1, wherein the processing input comprises an input moving a moving bar displayed when a number of execution windows displayed on the screen of the electronic device is greater than a certain number.

14. An electronic device comprising:
an application control module configured to:
display on a screen an execution window relating to at least one activity occurring according to an execution of an application,
remove an execution window corresponding to the stored activity from the screen, and
terminate the at least one stored activity;
a processor configured to receive a processing input of a user; and
a buffer configured to store the at least one activity corresponding to a range determined by a processing input.

15. The electronic device of claim 14, wherein the application control module is further configured to sequentially displaying a corresponding execution window when at least two execution windows occur for one application.

16. The electronic device of claim 14, wherein the buffer is further configured to determine a type or a number of activities stored based on at least one of a type or a movement range of the processing input.

17. The electronic device of claim 14, wherein the buffer is further configured to proportionally determine a number of the stored activities according to a number of entire execution windows displayed on the screen or a number of applications in execution.

18. The electronic device of claim 14, wherein the buffer is further configured to store related activities in a reverse order of an order in which the execution window is displayed on a screen.

19. The electronic device of claim 14, wherein the application control module is further configured to provide an effect of increasing or decreasing a transparency of the execution window according to a change of the processing input.

20. The electronic device of claim 14, wherein the application control module is further configured to remove the at least one stored activity from the buffer.

21. The electronic device of claim 14, wherein the processing input comprises an input for at least one fixed or dynamic button of the electronic device.

22. The electronic device of claim 21, wherein the processing input comprises a touch input for a point adjacent to the button or a touch input for an entire screen including an edge of a screen.

23. The electronic device of claim 22, wherein the touch input comprises a touch input moving from an edge point of the screen to a specified direction.

24. The electronic device of claim 14, wherein the processing input comprises a gesture input of a specified pattern.

25. The electronic device of claim 14, wherein the processing input comprises information on a user detected by a sensor of the electronic device.

26. The electronic device of claim 14, wherein the processing input comprises an input moving a moving bar displayed when a number of execution windows displayed on the screen of the electronic device is greater than a certain number.
